(19) United States
(12) Patent Application Publication
(10) Pub. No.: US 2011/0093262 A1
(43) Pub. Date: Apr. 21, 2011

(54) Active voice cancellation mask

(76) Inventors: Edward Raymond Wittke, Warwick, NY (US); Melissa Anne Wittke, Warwick, NY (US)

(21) Appl. No.: 11/715,765

(22) Filed: Mar. 8, 2007

Related U.S. Application Data
(60) Provisional application No. 60/780,145, filed on Mar. 8, 2006.

(51) Int. Cl. G10L 21/02; H04R 3/00

(52) U.S. Cl. 704/226; 381/122

(57) ABSTRACT

A method and apparatus for transmitting a clear voice signal while effectuating speech privacy and unobtrusiveness through adaptive signal processing; includes a voice input microphone, an electrical line for transmitting representations of the received voice signal from the microphone and having three modulators in it, actuators or speakers spherically disposed about the microphone and incorporated into a mask for creating sound canceling the ambient spatial transmission of the voice inputted into the microphone. The method and apparatus includes means to measure performance, re-introduce user's speech into the earpiece, reduced volume storage, and means to compensate for temperature dependencies. Cancellation actuators or speakers can be incorporated into said mask at various points including the interior mask surface, within the mask structure itself as well as on the exterior surface of the mask.

### CROSS REFERENCE TO RELATED APPLICATION

This application claims the benefits of earlier filed provisional patent application No. 60/780145 filed on Mar. 8, 2006.

### INTRODUCTION

1. Field of the Invention

This invention relates to voice transmission systems, and more particularly to voice transmission systems restricting the ambient area spatial dispersion of the voice.

2. Background of the Invention

Telephones are an essential part of modern societies. Privacy and noise issues related to phone usage have not been of great concern. However, as society now transitions from wired phones to wireless ones where phones are more and very often used in very public forums, these issues are of growing concern. Currently there is an exponential growth in the use of wireless phones. The use of phones, especially wireless or cell phones, in public forums results in:
Non-private phone calls—those people in close proximity can listen to your conversation; and
Obtrusive or intrusive noise—A phone call being made in close proximity becomes undesired background noise; being forced to listen to another person's conversation due to the fact they're in close proximity to yourself. Calls taken in public gatherings such as meetings, theaters, classrooms, churches and synagogues, museums, libraries, and restaurants, can be particularly intrusive.

The use of cubicles and other open office environments has become increasingly popular. The use of communication devices in these environments results in obtrusive noise. Calls made in these forums are not private.

Military communication privacy is also an issue especially during sensitive operations. Special operations forces are particularly sensitive to being overheard when communicating with other personnel.

Masks have been used in communication systems such as those of Air Force jet fighters, however mask themselves introduce noise such as echoes on the transmitted voice and masks don't actively cancel transmission of the user voice outside of the mask. A reduction in transmitted voice to a distant far field occurs by virtue of the structural properties of the mask but the cancellation is limited. In other words, a typical mask will reduce the radiated voice but will not entirely cancel the voice outside of a mask. A person in the vicinity of someone speaking into a mask will still overhear the person's conversation. A mask of the right thickness and materials may stop the person's voice from radiating outward however a mask of these properties would be uncomfortable and impractical. The use of active voice cancellation enables a balance to be stricken between mask density and materials and effective cancellation means.

There are voice cancellation systems that rather than cancel the person's voice emit “noise” which is either random audible content or some random human speech. These systems rather than cancel the person's voice attempt to mask it by introducing noise in the vicinity of the person speaking. One drawback to these approaches is a lack of portability of the systems. These systems tend to be designed for one user scenario such as corporate cubicle office environments.

3. Prior Art

Wittke in U.S. Pat. No. 6,952,474 effectuate the cancellation of a person's voice via a spherical configuration of cancellation speakers/actuators. The cancellation actuators are attached to a frame like structure and not incorporated into a mask like structure. The structure identified in Wittke, U.S. Pat. No. 9,952,474, is open frame structure that does not incorporate any type of physical boundary between the user and the environment around them. Sounds can freely flow in, out and around the frame like structure and attached actuators. A good analogy of a mask is the type of mask commonly used with Air Force jet fighter pilots where the mask forms a physical boundary around their mouth region and has solid structure to it. If the frame like structure in Wittke, U.S. Pat. No. 9,952,474, was instead a mask like structure the radiated voice pattern would be reduced by virtue of the solid mask and boundary characteristics. The radiated voice from within the mask to the outside environment would of course be dependent upon the characteristics of the mask itself. If the mask were dense and thick enough and the boundary between the user and the mask were perfectly sealed a mask quite possibly could achieve near perfect cancellation of the radiated voice to the outside of the mask. A couple of problems arise out of using a mask of this density. First of all ensuring 100% seal between the user's face and the mask is difficult to achieve. Secondly, a very dense mask with 100% seal around it forces the user to breath solely through their nose. Thirdly, a very dense and potentially heavy mask is potentially uncomfortable to the user. The more light weight and convenient the mask the more satisfied the user would be. The ideal scenario would be some compromise where the mask is dense enough to offer some level of cancellation but not obtrusive to the user. This realistic scenario where the mask does not offer near perfect cancellation but does offer some level of cancellation leads to the situation where some sort of active voice cancellation is still needed to cancel that which passes through the mask and in between the mask and the user's face. As mentioned in Wittke, U.S. Pat. No. 9,952,474, as a result of the non-perfect voice cancellation there potentially exists cancellation artifacts, “noise”, which corrupts the transmitted voice. This noise is removed in Wittke, U.S. Pat. No. 9,952,474. Incorporating a mask like structure would potentially reduce this corruption “noise”. Incorporation of a mask like structure into Wittke, U.S. Pat. No. 9,952,474, requires alteration of the Wittke design. When a mask is used in voice cancellation application the voice cancellation problem changes. One of the issues introduced when using a mask is echoes. When someone speaks within a closed structure which is in close proximity to their mouth echoes of their voice are produced. Echoes are reflections of the voice pattern within the structure. These echoes would need to be addressed in a voice cancellation design so as to allow for a more “normal” speech pattern being transmitted.

Berger and Jones in U.S. Pat. No. 5,526,411 cancel the local broadcast of a person's voice by introducing a phase-inverted signal (the “negative” of the person's voice) via speakers in close proximity to the mouthpiece of the phone. Berger and Jones describe a voice transmission system incorporating active sound cancellation to reduce the radiated voice signal of the user: in essence they endeavor to provide conversation privacy through cancellation of the person's voice using active signal processing. As the person speaks, an inverted cancellation signal (a cancellation signal derived from the user voice signal) is applied to a configuration of nearby (close to the person's mouth) actuators (i.e. speakers). This cancellation signal is intended to reduce the radiated far-field signal of the person voice: in essence providing privacy in possibly public scenarios, as an example.

A problem with their design is that the cancellation signal corrupts the transmitted signal being sent over the telephone infrastructure. In other words as the person speaks his or her voice signal will be transmitted to the caller on the other end of the phone, though “corrupted” by the cancellation sound being emitted from the actuators (i.e. speakers) and picked up by the telephone.

Another problem with their design is uniformity of non-obtrusiveness. Radiation of the person's voice pattern is omnidirectional (i.e. traveling in all directions) and the voice signal will have varying characteristics such as magnitude and phase depending on the geophysical position relative to the source signal. In other words the person's voice will appear different standing behind the person verses standing in front of them.

Berger and Jones also claimed that their system will provide the user with “complete privacy”. While in theory this may or may not be completely true, in practice active noise cancellation will reduce the target noise source, however usually not totally eliminate it. The patent alludes to the fact that it's a timing issue in regards to transmitting the voice signal over the telephone circuit. It's not as simple as transmitting the voice signal over the telephone circuit before being used for cancellation. The effect of the cancellation signal itself needs to be accounted for in the transmission path.

The corruption of the transmitted voice signal is not simply an echo like signal. Echoes are reflections of an original sound like that heard when yelling in a canyon. The corruption signal is some resultant residual from the application of the cancellation signal on the radiated voice signal in addition to echoes caused by the mask structure. Echoes are typically time delayed reduced amplitude copies of the original signal. A cancellation signal is an inverted signal not a delayed signal and the residual signal which impacts the transmitted voice signal is yet a third form of signal. In a perfect world the person's voice would be completely cancelled at some nominally short distance from their mouth with no artifact signals remaining. But the reality of current technology and natural science is that the cancellation will not be 100% and there will be residual components of the cancellation process that impact the voice signal transmitted to the far end party. Systems exist today for canceling background noise. These typically work the best for constant noise—such as the noise heard on a commercial airline—the rumbling of the engines and air streaming past the exterior surface of the plane. Noise cancellation of random short duration signals like when there is no apriori knowledge of the signal is more difficult. A typical noise cancellation system measures the incoming noise and attempts to cancel it all. While background noise like that heard in an airport terminal and the voice cancellation corruption signal can at a high level be both considered to be noise there are significant differences in what they are and how they might be removed from another signal. In the case of the airport terminal a simple microphone can be used to measure the noise signal to be removed. In the case of the voice cancellation system you would ideally want to measure the corruption signal in between the person's mouth and voice microphone and the cancellation speakers or actuators. However measurement of sound in this vicinity would include not only the corruption signal desired but also the person's voice. The question becomes “how do you separate out the corruption signal from the combination of corruption signal and original voice signal?”. The corruption signal radiates at the same time potentially as the person continues to speak. Because you just want to remove the corruption signal not the combination of voice signal and corruption signal from that which is transmitted to the far end party. Characterization of the corruption signal can be made through comparison and analysis of a resultant combined voice and corruption signal from application of a known and previously recorded voice signal to a voice cancellation system.

In the Berger patent, the same cancellation signal is sent to all of their speakers. In view of the directionality of voice, this leads to improper cancellation.

Another problem with their design is the retention of the cancellation speakers in a fixed orientation. The cancellation system performance is dependent upon the configuration and orientation of the cancellation speakers. Displacement of these speakers will effect the cancellation. If a user through ordinary use moves one or more cancellation speakers say from bumping into something the performance of the system will change. The Berger patent does not mention to use of a mask as part of a voice cancellation system. A more rigid—solid structure—like a mask would provide a higher level of strength to maintain the electrical components in a fixed geophysical configuration.

One problem introduced by the incorporation of a mask is that where the voice is detected and where it is to be cancelled may be physically different. The voice heard outside of a mask is different from that heard inside of a mask. If I wish to cancel the voice heard outside of the mask and the signal processing algorithm receives the person's voice from within the mask the algorithm needs to compensate for the effect of the mask on the voice. Likewise there may be discrepancies between where the cancellation signals originate from and where the effective point of cancellation is. If the cancellation speakers reside on the exterior surface of the mask and the point of cancellation is at the interior surface of the mask the signal processing algorithm needs to compensate for the effect of the mask on the cancellation signals.

In addition, certain electronic devices are sensitive to temperature and pressure. Cancellation system performance may depend upon environmental factors. Underlying signal processing algorithms may need to take into account variations due to environmental factors.

### SUMMARY OF THE INVENTION

Accordingly, it is an object of the invention to alleviate privacy and noise issues more effectively in voice transmission systems.

A further object of the invention is to provide a “clean” voice transmission signal, that is an “uncorrupted” signal, in the transmission line of a telephone system having a spatial sound cancellation feature.

Another object of the invention is to provide apparatus which can be an external attachment to the phone, incorporated within a phone handset itself or incorporated into a headset used in conjunction with transmission equipment (ex. A cellular phone).

The objects of the invention are achieved by the use of a signal processor which too receives the “corrupted” voice signal and removes from the transmission line the electrical signal component generated by the microphone in the telephone mouthpiece in response to a voice cancellation sound emanating from actuators or speakers spherically-disposed about the microphone as well as the effects associated with speaking within a mask. This action by the signal processor may be enhanced by sensors spherically-disposed at a greater distance than the speakers about the microphone.

Thus the device and method enables the transmission of a “clean” voice signal while accommodating the alleviation of the privacy and noise issues.

Also the device and method more effectively deals with the privacy and noise issues. They do this by reducing more precisely the radiated speech pattern emanating from the person using the phone. The device, in a retrofit design, attaches to the base of the phone in close proximity to the telephone mouthpiece. It consists of spherical configurations of arrays of actuators and sensors approximately four inches from the base of the phone and incorporated into a mask, and of a signal processing unit attached to the arrays or incorporated into the phone itself. The actuators cancel the speech pattern emanating away from the phone. The signal processor and the spherically-arranged far-field sensors precisely guide the spherically-arranged actuators or speakers. The device can be integrated into new phones or used as a standalone headset which attaches to a phone. The signal processor compensates for differences between where the voice is detected and where it is to be cancelled as well as differences between where cancellation signals are emitted and where the effective points of cancellation are.

### BRIEF DESCRIPTION OF DRAWINGS OF A PREFERRED EMBODIMENT OF THE INVENTION

These and other objects, features, and advantages of the invention will become apparent from a reading of the following description of a preferred embodiment of the invention, when considered with the attached drawings wherein:

FIG. 1 is a diagram outlining basic signal cancellation;

FIG. 2 is a diagram outlining a system incorporating the invention;

FIG. 3 is a diagram outlining a telephone system physical components in a user context, and showing one embodiment called out in Wittke, U.S. Pat. No. 9,952,474, of the associated voice input and far-afield sensors and cancellation actuators (speakers) in relation to the user and the phone; In this embodiment the cancellation speakers are mounted on a frame (herein referred to as Open Air mounting); the mask is a simple “frame” like structure;

FIG. 4 is a diagram outlining a telephone system physical components in a user context, and showing a second embodiment called out in Wittke, U.S. Pat. No. 9,952,474, of the associated voice input and cancellation actuators (speakers) in relation to the user and the phone; In this embodiment the far-afield sensors are not present; the same simple “frame” like mask structure as in FIG. 3;

FIG. 5 is a diagram outlining a telephone system physical components in a user context, and showing the preferred embodiment of the associated voice input and far-afield sensors and cancellation actuators (speakers) in relation to the user and the phone; This embodiment incorporates the use of a mask like structure; unlike the previous “frame” like structures this mask incorporates structural components in between main frame supports;

FIG. 6 is a diagram outlining a telephone system physical components in a user context, and showing a second embodiment of the associated voice input and cancellation actuators (speakers) in relation to the user and the phone; In this embodiment the far-field (error) sensors are not present although the mask is included;

FIG. 6a shows said apparatus, 1, separated into three components; a mouth centric module, 321, a connecting wire, 322, and an ear centric module, 320. Of course the wire, 322, could be replaced with a wireless connection;

FIG. 7 is a diagram describing how the effects of speaking within a mask must be removed from the voice signal to be transmitted to the far end recipient.

FIG. 8 describes how the voice cancellation problem is made easier with the use of a mask;

FIG. 9 is a diagram showing how the mask distorts the voice signal; the voice signal heard outside of the mask is not the same as that which would be heard if the person did not speak into a mask;

FIG. 10 is a diagram describing how the mask affects the cancellation signals;

FIG. 11 is a diagram showing how the cancellation actuators (speakers) can be placed on the exterior of the mask; The speakers can also be incorporated within the mask structure itself or on exterior surface of the mask; Additionally speakers can be incorporated using combinations of mask locations;

FIG. 12 is a diagram describing how the cancellation actuators (speakers) can be embedded within the mask itself;

FIG. 13 shows how displacement of the mask from a user's face will affect cancellation performance and how said effect will need to be compensated for;

FIG. 14 describes how the cancellation system might possibly be affected by environmental temperatures;

FIG. 15 describes how the cancellation signal sent to each actuator (speaker) may be different;

FIG. 16 shows one possible voice sensor orientation and mounting.

FIG. 17 describes how the cancellation system performance may be affected by how the mask is affixed to the user;

FIG. 18 describes how the point of cancellation may be within or outside of the mask.

FIG. 19 is a diagram showing how the cancellation signal is subtracted from the voice signal to be transmitted to the other party, by the signal processor which outputs also to the cancellation actuators after receiving not only the “corrupted” voice signal from the phone microphone but also inputs from the far-afield sensors; and

FIG. 20 is a diagram showing how the affects of the mask are used in the cancellation system. Specifically the voice signal used in the cancellation algorithm as well as the cancellation signals sent to the actuators (speakers) incorporate a mask effect. FIG. 5 represents a user oriented view of the same underlying design. The design outlined in FIG. 20 represents a design wherein the point Of voice cancellation is on the exterior surface of the mask.

FIG. 21 is a diagram showing an alternative embodiment wherein the point of cancellation is within the interior of the mask rather than at the surface (or exterior) of the mask as shown in FIG. 20. In this embodiment the signal cancelled is not distorted by the mask as in the FIG. 20 design. In this embodiment it is the original voice signal that is to be cancelled. Unlike FIG. 20, the geophysical point of voice cancellation is within the mask—meaning in the interior space between the inner surface of the mask and the user's facial surface. In this case the voice pattern to be cancelled is not altered by the mask structure as in the design of FIG. 20 above.

FIG. 22 is a diagram showing an alternative embodiment wherein the point of cancellation is within the mask structure itself rather than at the outer surface or exterior of the mask as in FIG. 20 nor on the inner surface or within the space between the inner surface of the mask and the user's face as shown in FIG. 21. Effectively the voice signal to be cancelled is not that picked up by the microphone, 2, but rather the voice signal seen within the mask structure. In this embodiment the voice signal cancelled is distorted by the mask as in the FIG. 20 design. Unlike FIG. 21, the geophysical point of voice cancellation is within the mask—meaning within the mask structure. In this case the voice pattern to be cancelled is altered by the mask structure as in the design of FIG. 20 above.

FIG. 23 shows an expansion of the voice path modulator, 14, into three potential sub-modules.

FIG. 24 shows how the mask like structure could potentially be reduced in volume for storage.

### DETAILED DESCRIPTION OF A PREFERRED EMBODIMENT OF THE INVENTION

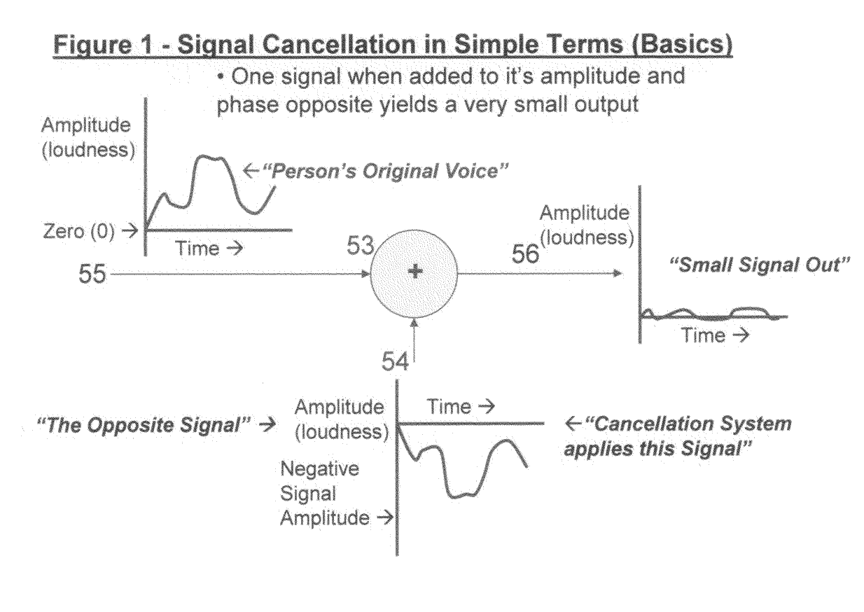

Referring now particularly to FIG. 1 of the drawings, there is shown therein a signal cancellation system wherein a signal 55 when added via a modulator 53 to an inverted signal 54 yields a small resultant output signal 56. The cancellation when put to practice is not 100%. Mathematically the resultant output would potentially be zero however given today's technology, possible implementations and usage affects typically result in less than perfect cancellation. Such imperfections in cancellation should be addressed in any product realization. FIG. 1 represents an ideal cancellation scenario absent of electrical signal and component delays, environmental factors such a mask and single dimensionality of the source single (meaning it is not omni directional as the human voice is). When a person speaks his or her voice emanates in many directions with varying signal characteristics such as amplitude and phase. This figure merely shows at a high level conceptually the goal of cancellation—reducing the original signal source by the application of some cancellation signal.

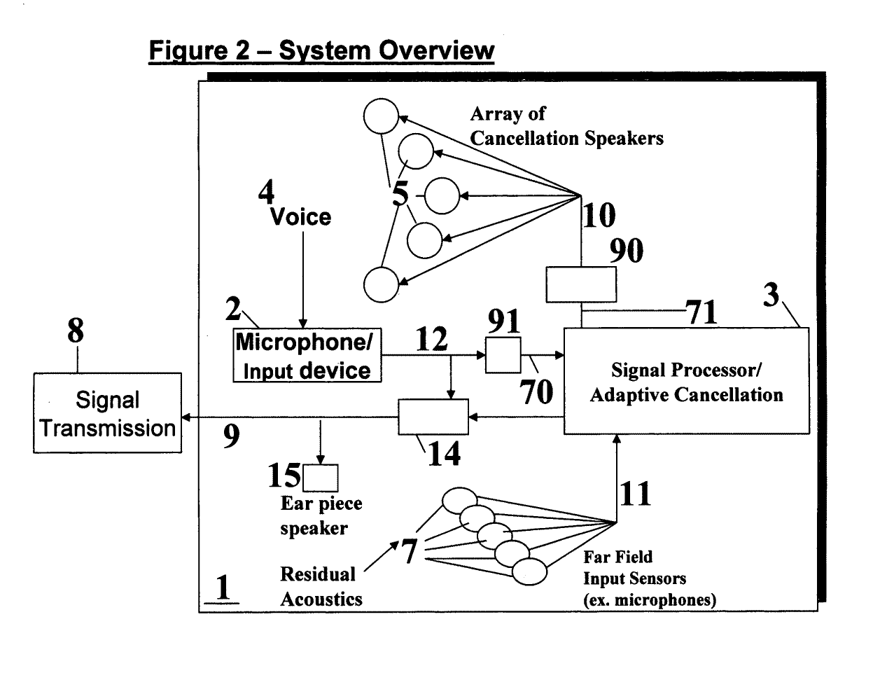

Referring now particularly to FIG. 2 of the drawings, there is shown therein a voice cancellation system 1 which interfaces with a voice transmission system 8. The voice transmission system 8 may be a wired or wireless phone or other voice or sound transmission mechanism. The voice cancellation system 1 includes input sensor(s) (microphone) 2, a signal processor 3, an array of cancellation actuators or speakers 5, and an array of far-field sensors 7, an ear piece speaker, 15, to reintroduce the cleaned voice signal in the user's ear. While FIG. 2 shows components at a conceptual level, the actual physical hardware arrangement may vary, given that technology often incorporates or integrates functionality within single Integrated Circuitry (IC) chips. Incorporated but not shown in the figure is a mask for encapsulating said system. The far-field sensors, 7, may also be used to detect environmental noise if the signal processor, 3, includes a component to cancel background noise external to the apparatus.

However the arrays of sensors 7 and actuators 5 are intended to indicate the need for multiple sensors and actuators in spherical configurations. They may or may not be actually disjoint in physical layout. The far-field sensors 7, commonly referred to as error sensors in the signal-processing field, could be microphones or any other sensing devices. Real Time adaptive signal processing algorithms 3 which generate cancellation signals based on input sensors and far-field sensors, are well documented in the field. Hardware as well as software solutions that implement these algorithms are commonly available.

The voice signal 4 includes the person's original voice, some form of the speaker 5 output from cancellation signal, 10, signals resulting from speaking within a mask and any background noise. For example, when a person's voice is recorded by way of a common microphone within a mask, the resulting recording includes the person's voice, echoes as well as all the background noise.

The voice cancellation system could also include a background noise cancellation component (not shown in FIG. 2) which could function to reduce the background noise which is transmitted along with the person's voice. This noise could be the sounds found in a typical commercial jet aircraft. The adaptive signal processing algorithms used for cancellation of background noise are very similar to those used for voice cancellation herein defined and are likewise well documented.

One possible implementation of the signal processing is defined by the flow diagram of Berger and Jones in U.S. Pat. No. 5,526,421. But there are a whole host of possible processing methodologies that could be used, including pure analog processing rather than the digital signal processing defined in U.S. Pat. No. 5,526,421. As previously mentioned numerous algorithms and methodologies exist and are well documented that effectuate cancellation signals given input sensor data.

As Berger and Jones mention in U.S. Pat. No. 5,526,421 much of the activity in the adaptive signal cancellation field has centered about cancellation of background noise. For example such systems have been used in the automobile industry to make the internal cabin quieter by canceling the external road noise. These adaptive algorithms have and continue to be used in cancellation of source signals as well: for example, in reducing the emanated noise from a military helicopter to make it less detectable by opposing forces.

Signal processing and adaptive cancellation has been around for years and the associated mathematical algorithms are well documented and used in quite a few products in industry today. Where once a system such as the one described here would have required custom hardware and would have been too big to commercially sell, today technology exists which makes this novel concept feasible and marketable.

In today's technology:
Noise cancellation algorithms exist—cancellation signals can be more complicated than an inversion of an input signal;
Actuators (speakers) exist;
Sensors exist;

Processor speeds are sufficient, particularly if the algorithm is simple as in inversions; dedicated devices could be used if very complex algorithms are needed in particular situations. And processor speeds are ever increasing.

The voice cancellation system 1 is also shown for convenience as including, but not necessarily so logically or physically, a modulator 14 to which the detected voice signal is also fed. It should be noted that the transmitted voice signal is partially derived from the signal processor 3, and not exclusively from the detected voice signal 4, being the detected voice signal as cleaned by the signal processor 3 via the modulator 14. This modulator removes the effect of the corruption of the voice signal by cancellation system artifacts and might as well remove effects such as echoes resultant from speaking within a mask as well as background environmental noise. Modulator 14 could also be combined with the signal processor, 3, into one overall signal processing suite of hardware and/or software.

The voice cancellation system 1 is also shown for convenience as including, but not necessarily so logically or physically, a modulator 91 to which the detected voice signal is also fed. Modulator 91 compensates for the effect of the mask 66 (not shown in the figure) on the detected voice signal at the point of cancellation. The signal 70 fed to the Signal Processor, 3, is that which needs to be cancelled. Modulator 91 accounts for differences between where the voice pattern is detected and where it is to be cancelled. If the system detects (via microphone 2) the voice within the mask but the point of cancellation is on the exterior surface of the mask the effect of the mask on the voice needs to be accounted for since the voice inside the mask will be different than that observed on the exterior surface of the mask. If modulator 91 is not used the cancellation signal will be incorrect. Additionally, microphone 2 which measures the voice signal 4 can be within the interior of the mask 66, within the mask, 66, itself or on the exterior of the mask 66. If the point of cancellation is the exterior of the mask 66 and the voice signal is measured within the mask 66 then modulator 91 compensates for the effect of the mask 66 on the voice signal. The effect of the mask 66 on the voice signal is referred to as PlantA. As mentioned previously, a person's voice heard outside of a mask is not the same as their original voice. If the point of cancellation is in the space between the interior surface of the mask 66 and the user's face the PlantA is unity, meaning it could be replaced by a simple wire; direct path with no modulator. If the point of cancellation is either within the mask 66 itself or on the exterior of the mask PlantA is non-unity. A unity plant means the box is not needed in that particular embodiment. Modulator 91 is called out in FIG. 2 as a separate module from the signal processor, 3. Modulator 91 could also be combined with the signal processor, 3, into one overall signal processing suite of hardware and/or software.

The voice cancellation system 1 is also shown for convenience as including, but not necessarily so logically or physically, a modulator 90 to which the cancellation signal from the signal processor 3 is fed. Modulator 90 compensates for the effect of the mask 66 on the cancellation signals. More specifically modulator 90 compensates for the effect of the mask 66 on the cancellation signals 10 that are emitted by the speakers 5. The sounds emitted from the speakers 5 are affected by the mask 66 when the speakers 5 are embedded within the mask 66. For example, the sound played from a single speaker 5 which is within the mask 66 is different from the sound observed at the exterior of the mask 66. The sounds observed within the interior of the mask 66 when speakers 5 are activated, is potentially different from that observed on the exterior of the mask 66. Modulator 90 takes the effect of the mask 66 on the cancellation signal 10 into effect. The sounds heard from a cancellation speakers in open air are different from those heard when the same speakers are embedded within a mask. Knowing the affect of the mask on the speaker as heard outside the mask allows the signal processing to send to appropriate signal to these speakers to cancel the person voice effectively at the exterior/interior surface or within the mask. If the cancellation speakers are mounted on the inner surface of the mask PlantB would be unity for example. Modulator 90 could also be combined with the signal processor, 3, into one overall signal processing suite of hardware and/or software.

Shown also in FIG. 2, is an ear piece speaker, 15, to reintroduce the person's voice into their ear so as to maintain normal speech. How loud a person speaks is dependent upon what they hear with their ears.

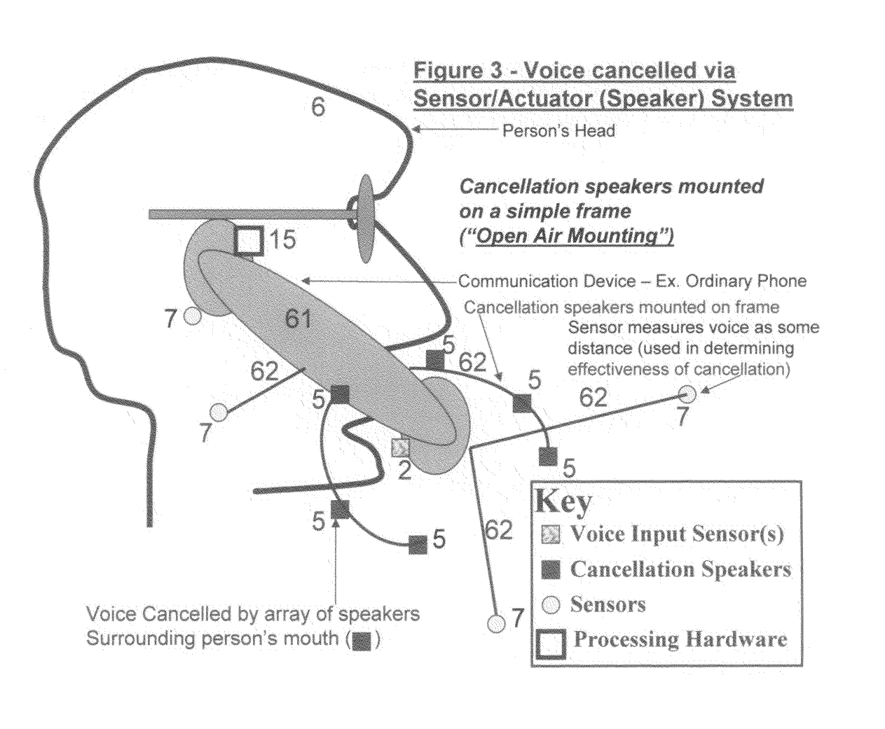

FIG. 3 shows one embodiment of the actual physical layout of the input voice sensors 2, of the far-field sensors 7, and of the cancellation sources (actuators or speakers) 5, in relation to a person's head 6 and associated phone handset 61. Additionally the phone handset, 61, could be recast into a mouth centric device which is separate from the ear piece but connected via wire or wireless connection. The phone handset, 61, is shown in most of the figures for convenience. The configuration of the sensors 2 and 7 and actuators or speakers 5 is important. The input voice sensor 2 must be located in close proximity to the person's actual mouth. The cancellation actuators or speakers 5 form a spherical array pattern about the person's mouth and are at a greater distance from the mouth than the voice sensor 2. These actuators 5, which may be miniature speakers, cancel the person's voice in the space extending away from the phone mouthpiece where the input voice sensor 2 is located. In this embodiment the mask is represented as a simple “frame” like structure without structural material between said frame members. The configuration is also referred to as the “open air” mounting—meaning air flows freely around this simple frame structure.

The far-field sensors 7 are situated spherically about the mouthpiece but at a farther distance from the mouthpiece than the actuators or speakers 5. They serve to detect how well the cancellation actuators or speakers 5 worked, and to feed back error signals to the signal processor 3. For example, if a large error is detected at a far-field sensor, then the corresponding actuator in the area may need to emit a larger cancellation signal.

A person's voice will be greatly reduced in the vicinity of his or her mouth by the system. Thus he or she will not be able to hear their own voice as they normally would. Part of how people talk is a reflection of how they hear their own voice.

Therefore, a representation of the person's voice is sent by the signal processor 3 to the phone receiver's speaker 15 so that the sound of his or her voice is emitted from the ear piece of the phone. Otherwise the person would instinctively raise his or her voice to compensate for the reduction in the heard sound of their own voice, negating privacy and raising intrusive noise. In the telecommunication industry this is known as “sidetone” and the re-introduction of voice signals into the ear piece is commonly found in today's phones. Insertion of voice signal is done currently because the ear piece when held close to one's ear reduces the person's reception of their own voice. In the case of this invention the reduction of reception of the speaker's voice will be much more dramatic. A much larger amplitude voice signal will be needed to be inserted into the earpiece of the phone.

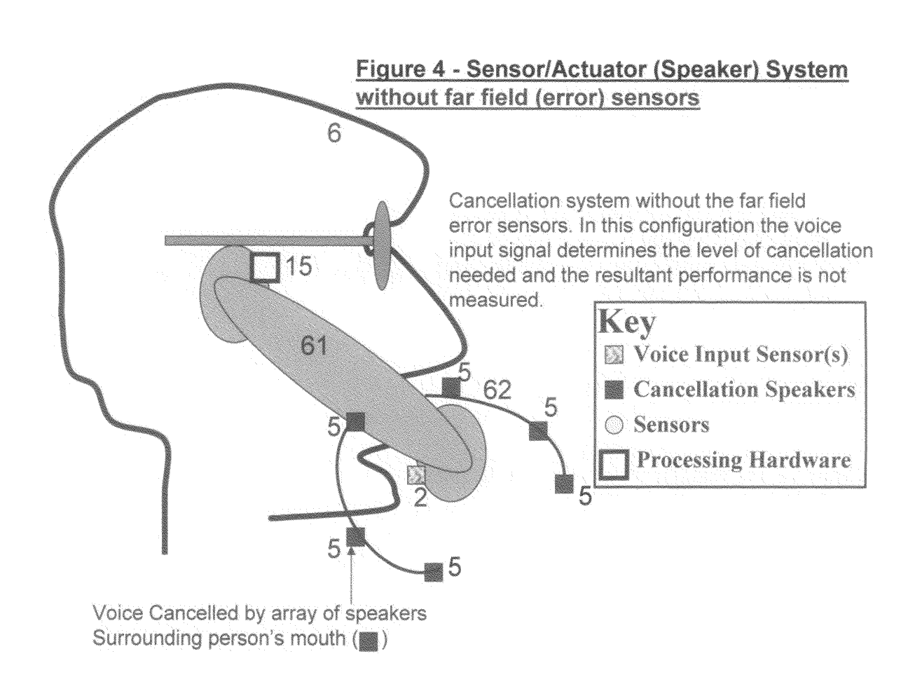

FIG. 4 diagrammatically depicts a second embodiment incorporating the “open air” mounting mask without the use of the far field error sensors. In this configuration the cancellation signal processing would not incorporate error signals. Error signals provide a measure of system performance back to the signal processor 3 by which the cancellation system can adjust the cancellation signals to improve performance over time.

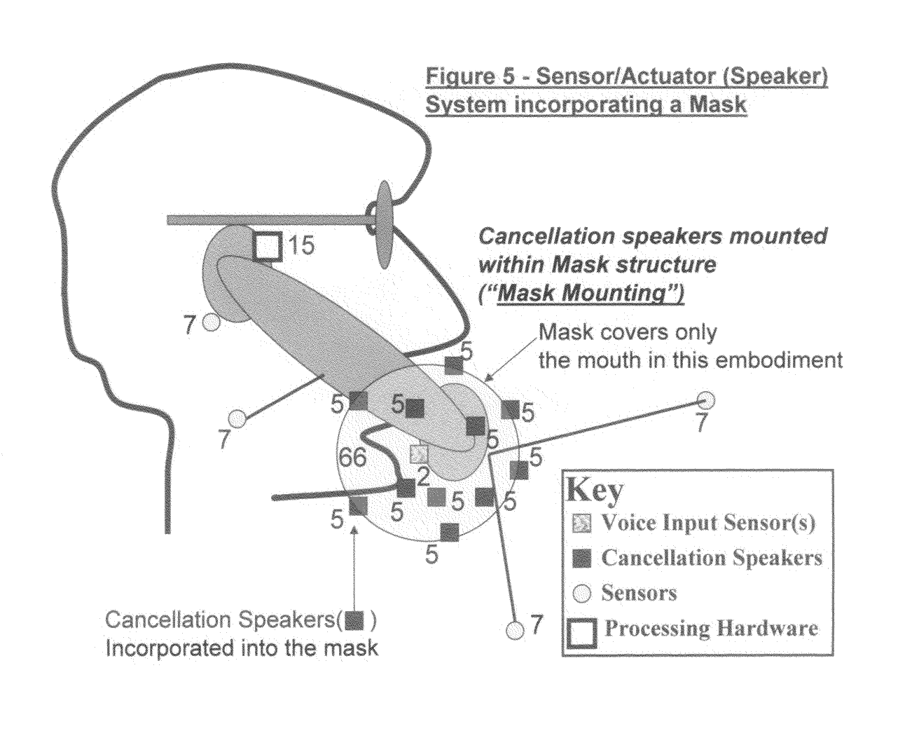

FIG. 5 represents the preferred embodiment of this invention wherein the mask represents more a typical mask rather than a simple frame like structure. Cancellation speakers/actuators 5 are mounted either within or on the interior or exterior of the mask 66. Error sensors 7 are mounted at a distance greater than the cancellation speakers 5 measured from the person's mouth or voice microphone 2. In this rendition the mask covers only the person's mouth not their nose. The mask could possibly cover the person's nose and or a greater portion of their head.

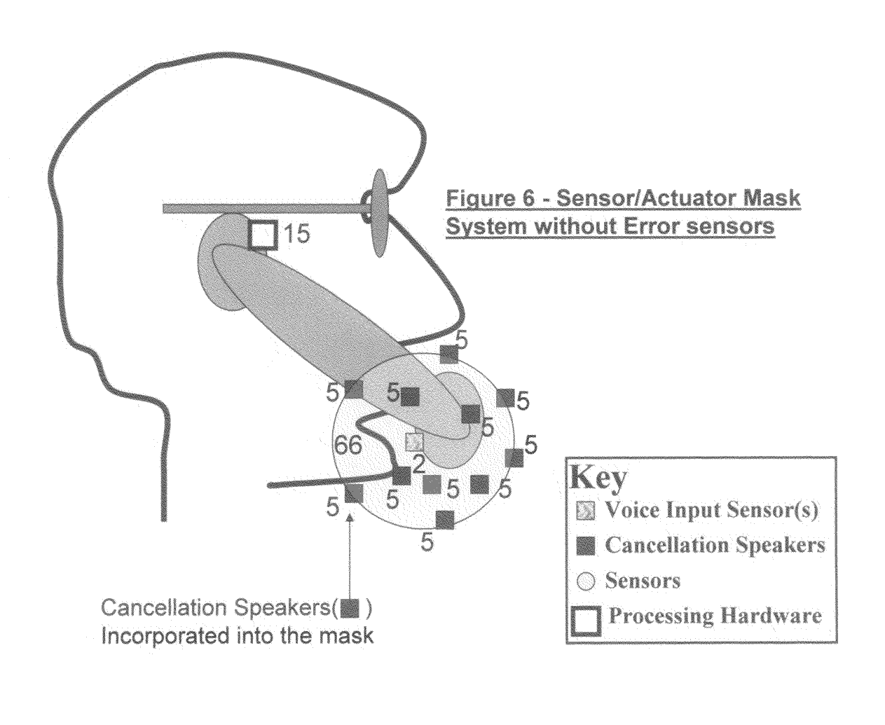

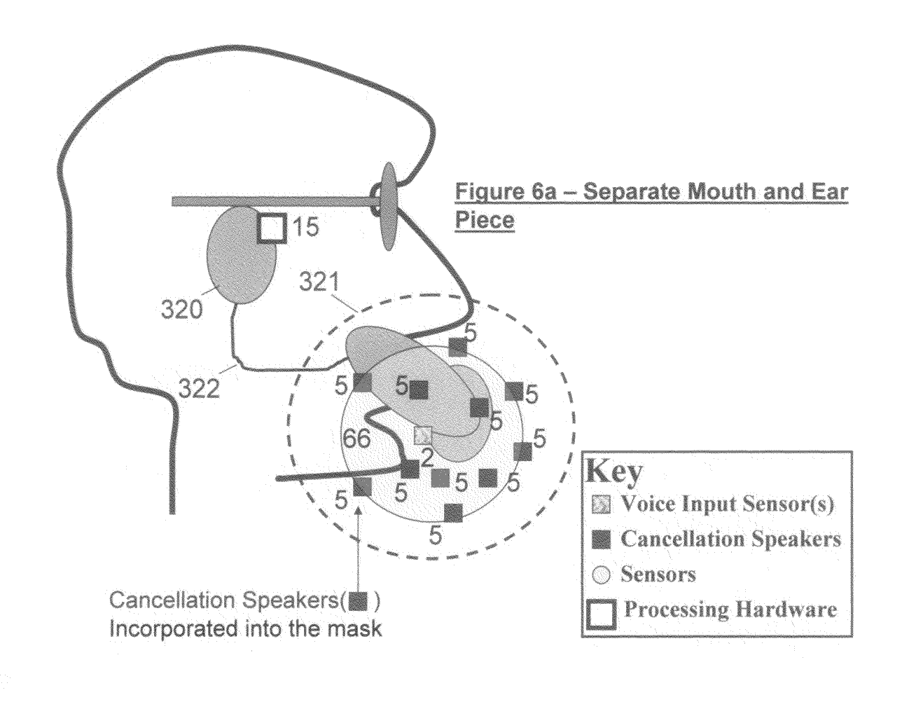

FIG. 6 represents the mask cancellation system without the use of error sensors. Cancellation speakers/actuators 5 are mounted on or within the mask 66. The person's voice is detected by microphone 2. The person's voice is reintroduced into the earpiece via speaker 15.

With “open air” mounting unless the cancellation speakers are mounted on a strong frame users will displace them (i.e. move them around) from normal use thus deceasing the effectiveness of cancellation. The signal processing is dependent upon the geophysical orientation and location of the speakers and sensors. A mask by its very nature will reduce the person's transmitted voice. This reduction however will not be 100%. A mask will also better maintain the sensors and speakers (actuators) in a fixed arrangement. The voice cancellation problem is more difficult using the open air mounting rather than a more typical mask that has a more solid structure. An enclosed mask may however be less comfortable than the open air configuration. The cancellation is also effected by how closely the mask is held to the person's face. Gaps between the mask and the person's face will affect the cancellation of the person's voice. The effects of speaking within a mask need to be removed from the voice signal being transmitted to the other party being spoken to.

FIG. 6a shows a mouth centric module, 321, connected via wire, 322, to an ear piece module, 320. Wire, 322, connecting modules 320 and 321 could be replaced with a wireless connection, not shown in the figure. The point to this figure is to show that the handset, 61, shown in most of the figures could just as easily be recast into two separate modules, 321 and 320.

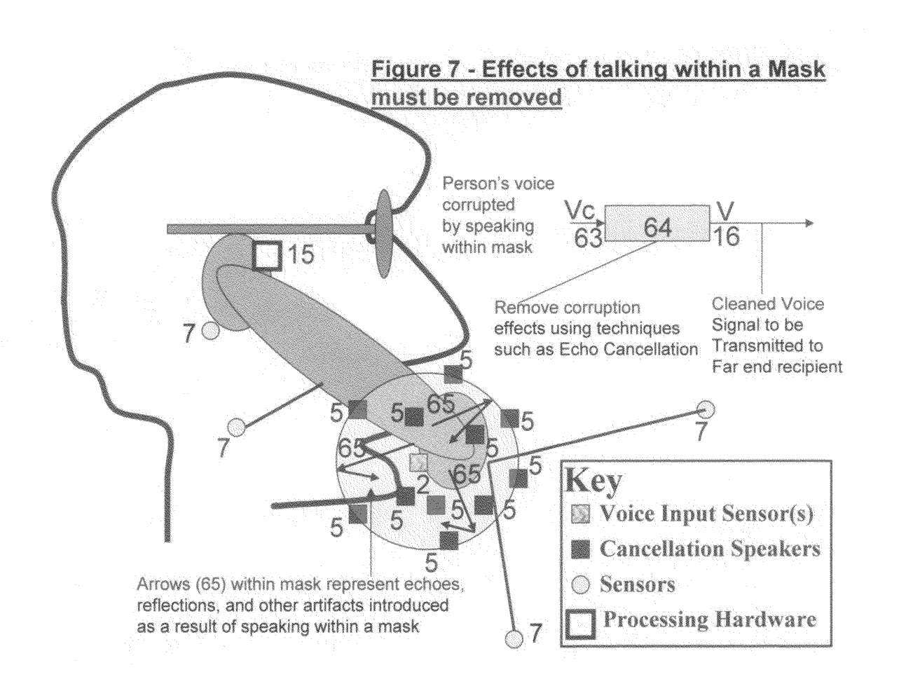

FIG. 7 diagrammatically depicts echoes 65 of the person's voice within the mask. Voice microphone 2, error sensors 7 and cancellation speakers 5 are represented as well. The person's voice corrupted by signals such as the echoes 65 is represented by Vc 63. Vc, 63, is cleaned by signal processing module 64 to output an original voice signal 16. The corruption of the voice due to speaking within the mask is removed by signal processing techniques such as echo cancellation. Such techniques are commonly known and will not be elaborated on herein. This figure addresses the issue of removing the effects of talking within a mask. Remembering that the person's voice is corrupted by virtue of talking within a mask, by artifacts of the cancellation process, and thirdly by external environmental noise. Module 14 in FIG. 2 previously addresses potentially all three forms of signal corruption. Modulator 64 called out in FIG. 7 would represent a subset of the functionality of modulator 14 in FIG. 2.

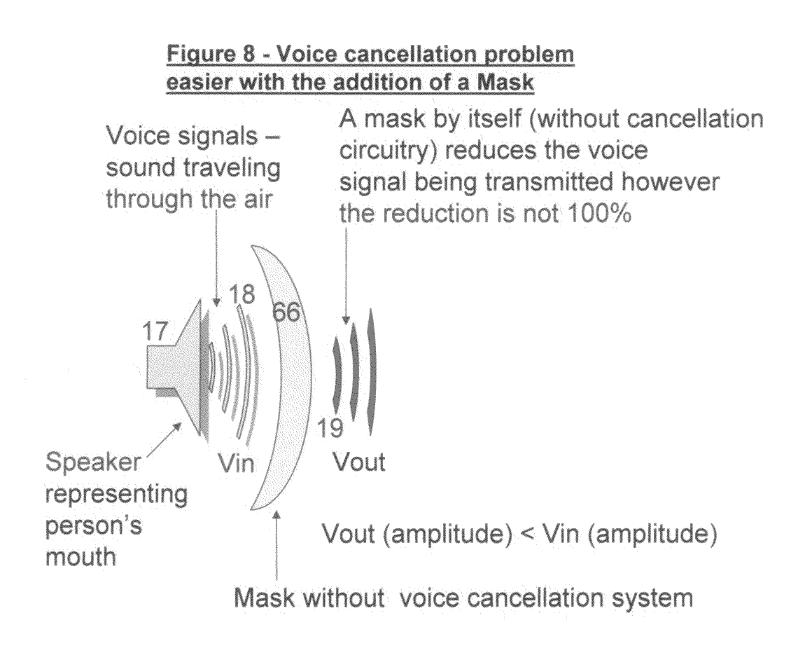

FIG. 8 pictorially shows how the voice cancellation problem is made easier by the simple introduction of a mask. The spoken voice 18 within the mask 66 is of larger amplitude than the voice signal 19 observed outside of the mask. A typical mask will reduce the emitted voice signal however the reduction is not 100%. Speaker 17 represents the person's mouth. Such speakers are used in designing cancellation systems.

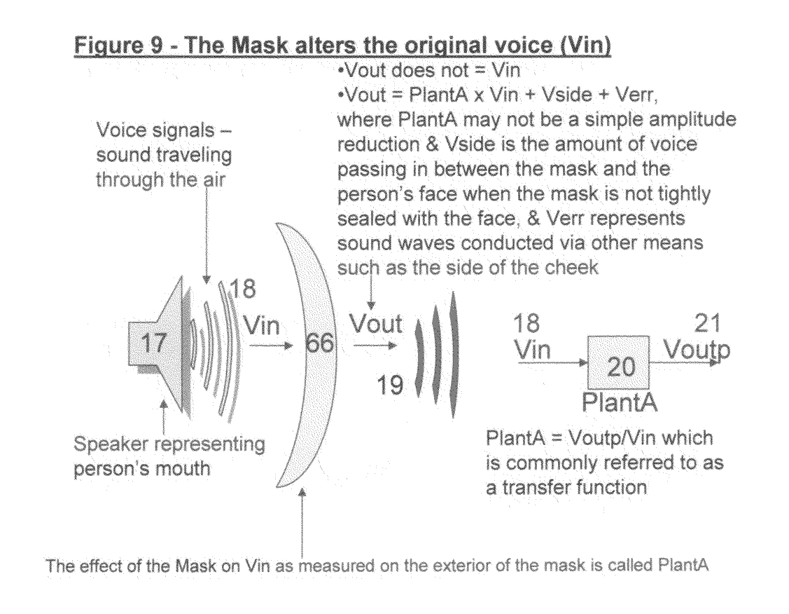

FIG. 9 takes the affect of the mask on the voice a step farther. The reduction of the emitted voice signal as it passes through the mask can be characterized and represented mathematically. The affect of the mask 66 on the voice in 18 is represented as PlantA, 20. Voice out, Voutp,=PlantA X (times) Vin 18. The voice heard outside of the mask includes the voice passing through the mask, voice signals passing in between the mask and the person's face, called Vside in the figure as well as sound waves conducted through other means such as the person's cheek. The important point being you can mathematically characterize the effect of the mask on the voice herein called PlantA. A cancellation system has an effective point of cancellation—that point in space where it drives the signal it wants to cancel to zero. In the case of the mask there are three possible places to cancel the voice signal 1) within the mask interior (between the person's face and the interior mask surface), 2) within the mask structure and 3) on the exterior (outside) of the mask. If cancellation system is set up to cancel the voice emanating from the exterior of the mask and the person voice is measured within the mask itself (the mask interior—in between the person's face and the interior surface of the mask) then the effect of the mask on the voice signal must be taken into account. In this example the voice signal that needs to be cancelled is not the one observed or measured within the mask interior but that which would be heard at the exterior of the mask. Effectively the voice signal to be cancelled at the exterior of the mask is the person's voice measured within the mask times PlantA (given Vside and Verr are zero). From a system design standpoint the best place to measure the person's voice is very close to their mouth. In a simplistic example PlantA for the mask could simply be a 50% reduction in amplitude (the person's voice is reduced by 50%) as observed by the difference between a signal resultant from a microphone placed between the person's mouth and the interior surface of the mask and a signal observed at a point on the exterior surface of the mask. PlantA in this simplified example would be represented by the value 0.5. So if Vin had an amplitude of 10, Voutp would equal 5. If the objective is to cancel the signal at the exterior of the mask and the voice is detected via a microphone within the interior cavity (between the person's face and the interior surface of the mask) then the signal processor must cancel a signal of amplitude 5 in this simple example. One method of characterization of PlantA would be to emit a known signal (which would be Vin) from within the interior of the mask (in between the person's face and the interior surface of the mask) with the mask fitted to an individual, measure the signal observed at the exterior of the mask (which would represent Voutp) and then mathematically calculate PlantA which would be Voutp divided by Vin. Another way to determine PlantA would be to record the person's voice via a microphone as described above (which again would represent Vin), record the person's voice at the exterior via a second microphone (call this signal Voutp) and once again determine the function (PlantA) which when multiplied by Vin would yield Voutp. Signal processor, 3, may also incorporate Vside and Verr in the algorithm used to generate the cancellation signals, 10.

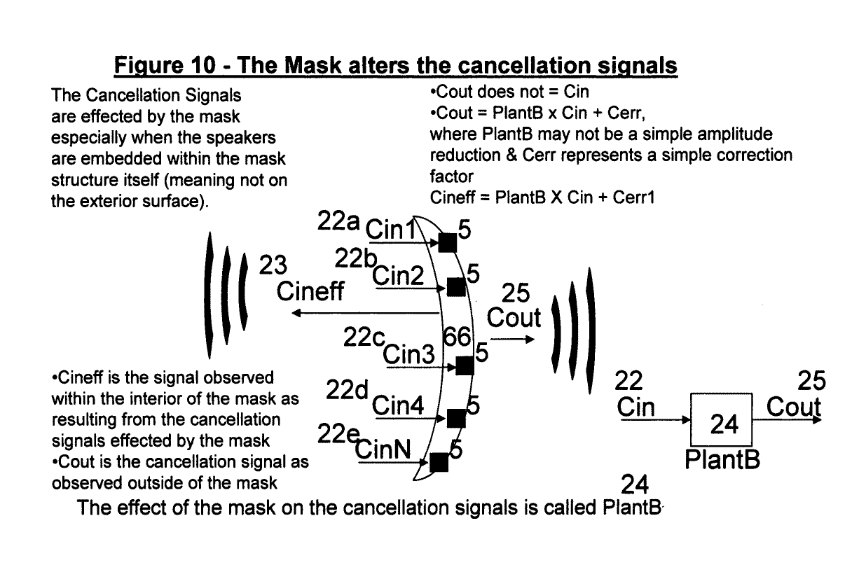

Similarly the mask will affect the cancellation signals as shown in FIG. 10. If the cancellation speakers (actuators) are on the exterior surface of the mask and the point of cancellation is the exterior of the mask the mask obviously has no affect on the cancellation speaker's performance, unless of course the speakers are mounted on the mask in such a way as to alter the original cancellation signal emissions. If the cancellation speakers are within the mask structure itself, the mask will affect the cancellation signals as observed within the interior (between the person's face and the interior surface of the mask) or exterior surfaces of the mask. The cancellation speakers can be mounted in three places: 1) on the interior surface of the mask, 2) within the mask structure itself and 3) on the exterior surface of the mask. The point of cancellation typically will not be all three locations—just one. As shown in the figure the affect of the mask on the cancellation signal Cin 22 is PlantB 24 which results in an output signal designated by Cout 25. Cin1 through CinN are the cancellation signal applied to the cancellation speakers 5 shown in the figure. These speakers are depicted as being within the mask structure itself 66. Each of the Cin's are unique—meaning the individual cancellation signals sent to each and every speaker may not be the same. They could be the same but optimally they should be unique. The cancellation signal measured outside of the mask is labeled Cout 25 and that measured within the mask is labeled Cineff 23 for Cancellation In Effective. Cout and Cineff are effectively the cancellation signals measured at the exterior and interior of the mask. Cout equals the input cancellation signal times the effect of the mask called PlantB plus an error component called Cerr. Cineff equals the cancellation signal times the affect of the mask labeled PlantB plus an error factor called Cerr1. It should be noted that PlantB will vary depending upon the point of cancellation and the point of origin of the cancellation speakers. Accordingly PlantB in the equations noted in FIG. 10 for Cineff and Cout are different. The variable PlantB assumes different values depending on the cancellation circumstances. What is important to remember is that the effect of the mask on the cancellation signals needs to be accounted for. A simple example here might be the mask introduces a simple amplitude reduction of 20% of the cancellation signal as observed between the cancellation signal amplitude from a signal emitted from a speaker mounted within the mask structure itself and the amplitude of the signal observed at a point on the exterior of the mask. In this example the desired point of cancellation is said point on the exterior of the mask, but as stated the cancellation speaker is mounted within the mask structure itself (physically two different locations). In this example PlantB would be 20% and if CM equaled 10 then Cout would equal 8 (given Cerr was zero). One method of characterization of PlantB would be to emit a known signal (which would represent CM) from the cancellation speaker or actuator, measure the resultant signal (which would be Cout) at the point of cancellation (in this example above it is at a point on the exterior surface of the mask) and determine the mathematical function (PlantB) which when multiplied by CM yields Cout (PlantB=Cout divided by Cin) for a given Cerr of zero.

The interior of the mask can optionally incorporate sound absorbing materials—rather than a reflecting surface such as smooth plastic.

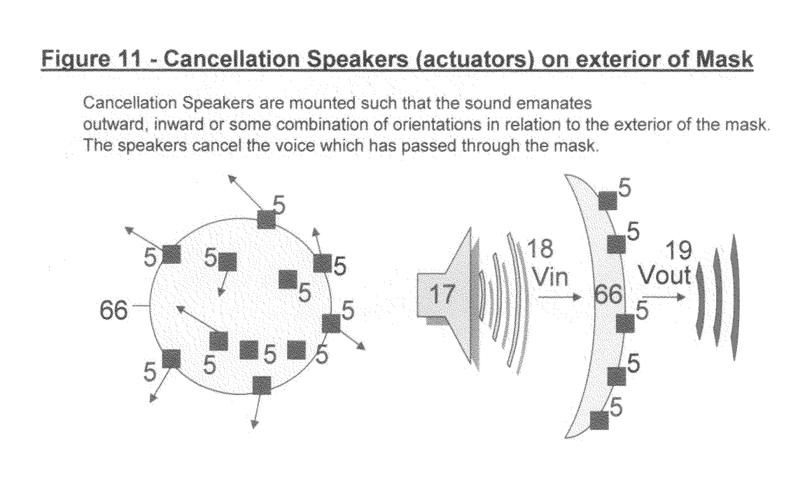

FIG. 11 shows the cancellation speakers 5 mounted on the exterior of the mask 66. The voice measured on the exterior of the mask is called Vout 19 and that measured within the mask is called Vin 18. Sound from the speakers emanates either away from or towards the exterior surface of the mask. Additionally the speakers can assume other orientations or combinations of orientations in the case of multiple speakers.

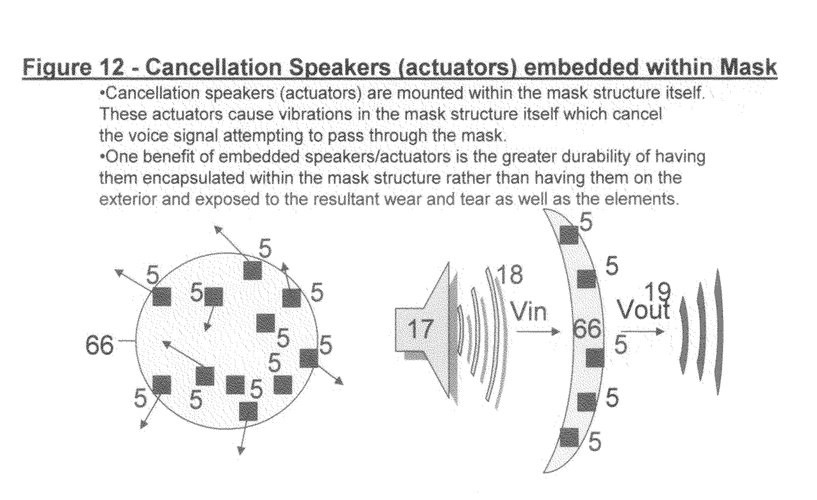

FIG. 12 depicts the cancellation speakers 5 being mounted within the mask structure itself 66. The speakers (actuators) cause vibrations in the mask structure which cancel the voice signal attempting to pass through the mask. Having the speakers within the mask increases the durability of the system—having them encapsulated within the mask itself—protected from the elements. Speakers are mentioned here as one possible type of actuator. Other types of actuators can be used that result in the emission of cancellation signals.

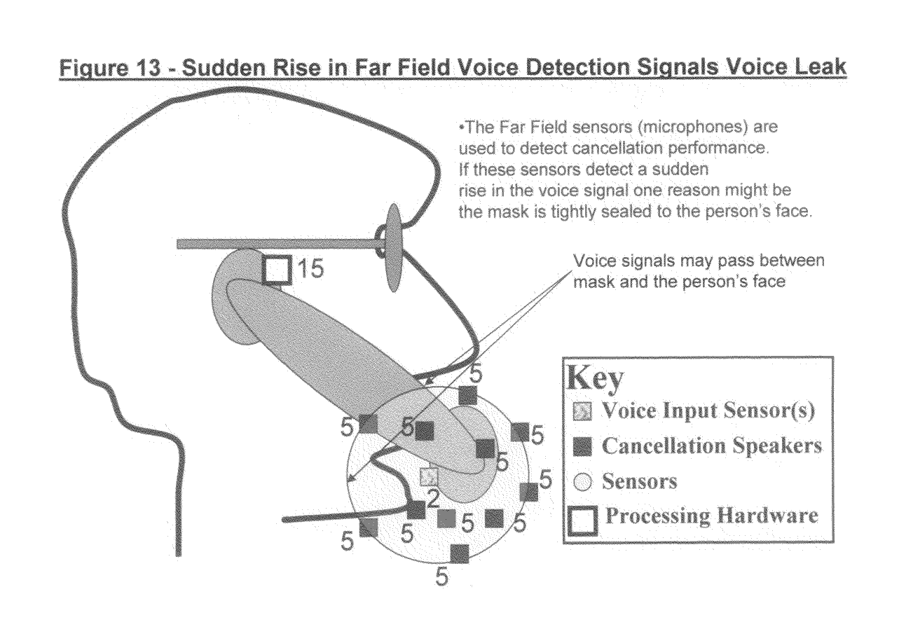

FIG. 13 discusses the condition where the mask does not form a tight seal to the person's face and voice signals slip through the gap in between the mask and the person's face. The far field sensors in this case would detect a sudden rise in the person's voice. The system could alert the user of the “loosely” fit mask. The system could also adjust the cancellation signals to compensate for the leakage. For example if the mask had a gap on the right side the system could increase the cancellation signals sent to actuators in that vicinity to compensate for the increase in voice emissions.

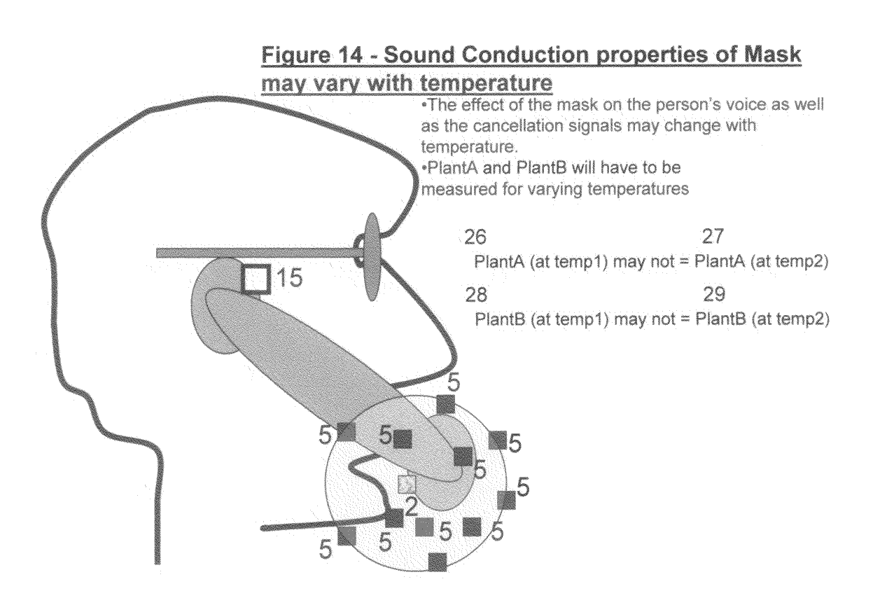

FIG. 14 depicts the possible dependency of the Plants (PlantA and PlantB) on temperature. Quite often electronic components will operate slightly different at different temperatures. In one embodiment the signal processing algorithms will incorporate factors for accounting for changes in these Plants due to temperature.

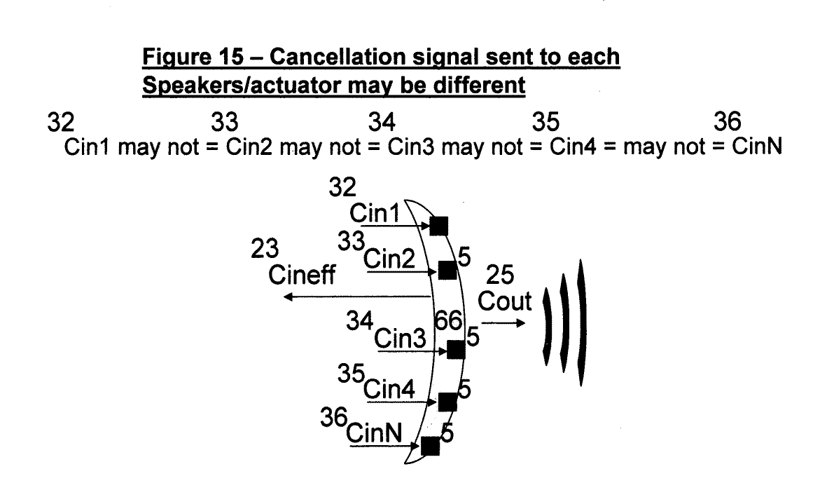

FIG. 15 depicts the fact that the cancellation signal Cin1 32 through Cin N 36 sent to each speaker 5 within mask 66 may not be the same. The voice signal to be cancelled directly in front of the person's mouth is greater than that off to the side of the mouth. Therefore the invention herein disclosed includes the ability to send unique cancellation signals to all cancellation actuators.

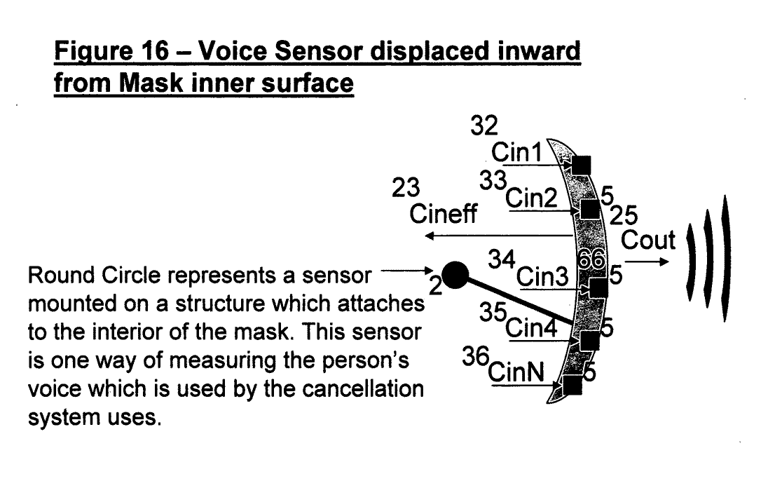

FIG. 16 depicts a voice sensor (microphone) 2 being attached to the interior surface of the mask 66 and mounted on a support member which extends it inward. This diagram presents an alternative to mounting the voice microphone on the telephone handset near the mouthpiece.

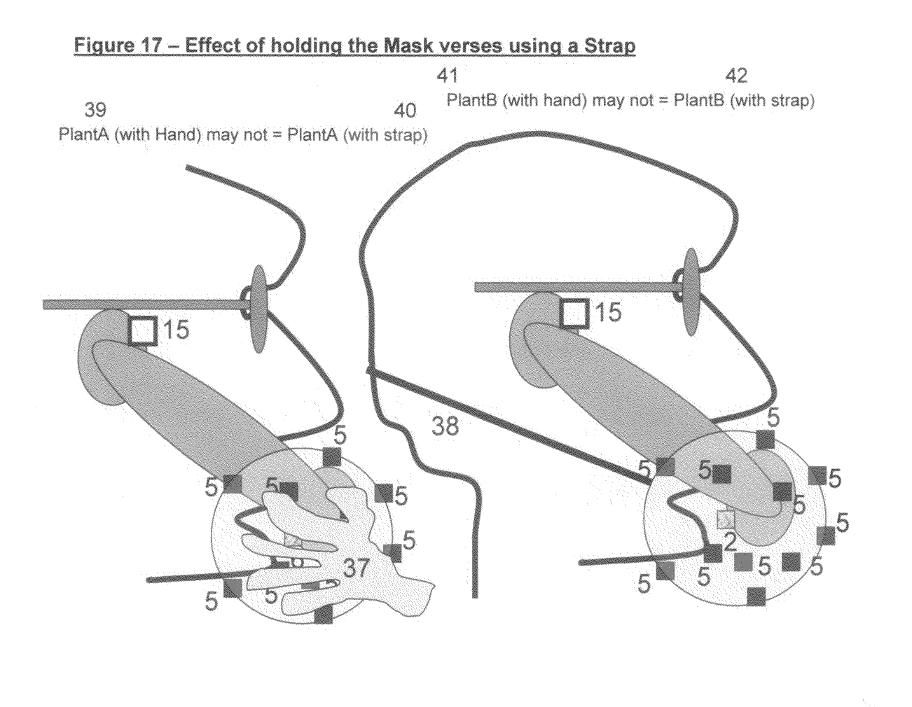

FIG. 17 diagrammatically shows how the Plants will potentially vary when the mask is held by the user verses being held in place by a strap. The effective PlantA 39 when the mask is held by the person's hand 37 may not equal the PlantA 40 observed when just using a support strap. Likewise the effective PlantB 41 when the mask is held by the person's hand 37 may not equal the PlantB 42 observed when just using a support strap.

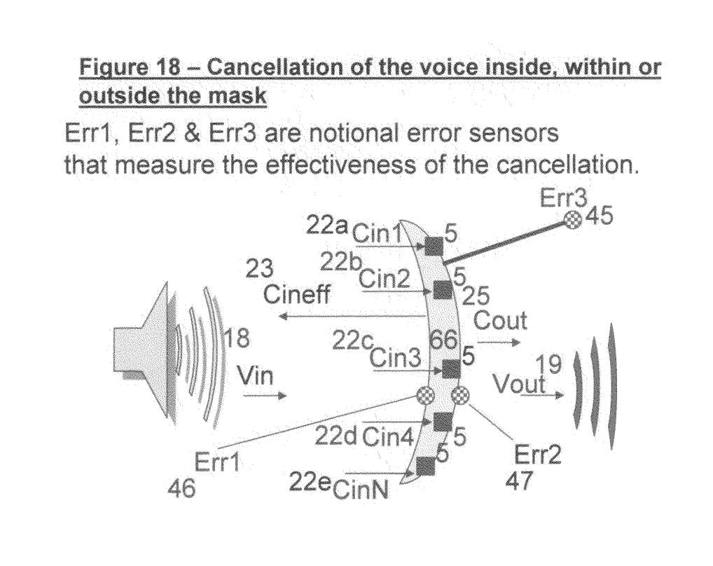

FIG. 18 elaborates on the concepts that the voice signal can be canceled within the interior of the mask, within the mask structure, on the exterior surface of the mask itself or on exterior at some distance from the mask. Shown are three possible error sensors (45, 46 & 47) locations. The cancellation error (or effectiveness) could be measured at any of the three locations.

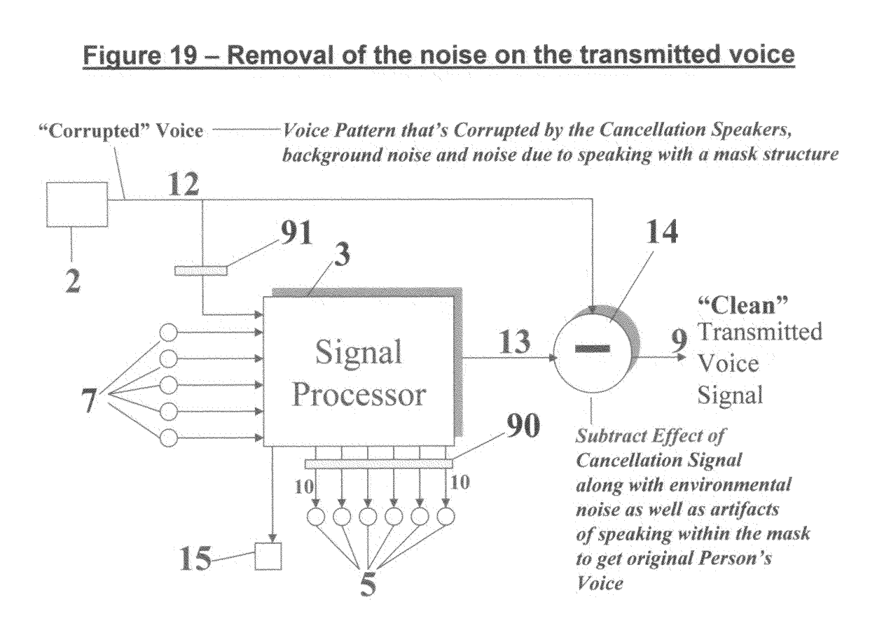

FIG. 19 diagrammatically depicts how the voice input signal 12, which is “corrupted” output from the input sensor(s) 2, is used to generate the transmitted “clean” voice signal 9. As previously stated, from the signal 12 is subtracted some form of the cancellation signal 13 derived from the signal processing algorithm wherein the resulting output signal 9 is then transmitted out to the recipient person or other party.

As previously indicated, the input voice sensor(s) 2 detects the person's voice 4 which contains the true voice, the background noise, artifacts and noise due to speaking within a mask and some form of the cancellation signal process residual. Then the detected voice signal 12 is sent to the signal processor 3 and to the modulator 14. The signal processor mathematically utilizes the input signal 12 and the far-field signals 7, and outputs the voice cancellation signals 10 to the actuators or speakers 5. At the same time the signal processor 3 also sends a subtraction signal relevant to earlier voice cancellation signals, to the modulator 14 to remove representations of them from the transmitted voice signal 9 downstream of the modulator. The subtraction signal also includes components associated with background noise and effects due to speaking within the mask.

It will be appreciated that system 1 operates in real time to transmit a “clean” or “uncorrupted” voice signal 9 while effectuating conversation privacy to a user 6. Signal processor 3 output cleans the “corrupted” voice signal 12 by receiving the “corrupted” voice signal 12, and the output of far-field sensors 7. Other signal processor 3 outputs feed the actuators or speakers, 5, through modulator 90 to effect spatial voice cancellation, and the phone receiver speaker 15 to enable the user to properly hear his or her own voice.

It is important that the actuators or speakers 5 and the far-field sensors 7 be in a spherical array configuration about the mouthpiece microphone 2. The signal emitted from each speaker of the array will be tone and strength varying; e.g., the speakers directly in front of the person's mouth will emit a stronger signal than those lying to the side of the person's head.

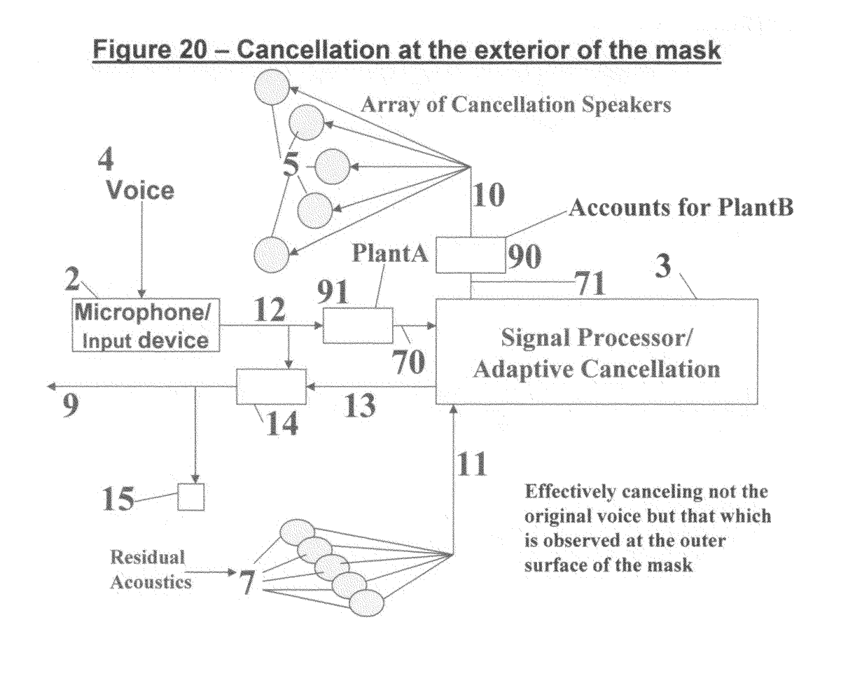

FIG. 20 diagrammatically depicts how the voice input signal 12, which is “corrupted” output from the input sensor(s) 2, is used to generate the transmitted “clean” voice signal 9. As previously stated, from the signal 12 is subtracted some form of the cancellation signal (as well as noise artifacts due to speaking within the mask and background noise) 13 derived from the signal processing algorithm wherein the resulting output signal 9 is then transmitted out to the recipient person or other party. Voice signal 12 input to modulator 91 which modifies the signal to account for the affect of the mask and inputs the resultant signal 70 into signal processor 3. This figure describes the situation where the voice is measured within the mask (within the space between the interior surface of the mask and the person's face), the point of cancellation is the exterior of the mask and the cancellation speakers are within the mask itself. The cancellation signal 71 output from the signal processor 3 is input to the modulator 90 which multiplies the signal by a mathematical representation of the affect of the mask on the cancellation signal to produce cancellation signal 10. Let's take a simple example; In this example the person's voice is measured via a microphone placed between the person's mouth and the interior surface of the mask (the interior cavity). The point where we want to cancel their voice however is on the exterior surface of the mask. Knowing that the mask has an effect on the person's voice using the voice signal measured via said microphone directly in the signal processing algorithm would be incorrect. The voice signal we really want to cancel is that seen at the exterior surface of the mask not the one observed via said microphone. Modulator 91 compensates for this difference in signals. Like the simple example earlier in this example the mask may represent a simple 50% amplitude reduction in signal strength as observed between the signal measured via said microphone and that observed at the exterior surface of the mask. In this example PlantA is 0.5 and modulator 91 would reduce the voice signal, 12, sent to the signal processor by 50%. PlantA in the real world may of course be more complex including a phase shift for example. But as stated earlier PlantA can be measured and characterizes mathematically. In this example the cancellation speakers are mounted within the mask itself but the point of cancellation is a point on the exterior of the mask. And as stated earlier the mask will affect the cancellation signal that propagates to the exterior surface from within the mask structure. In this example the mask represents a simple 20% reduction in signal amplitude as observed between the signal emitted from the speakers and the signal observed at the point on the exterior surface. In this case PlantB equals 0.8. PlantB noted in FIG. 20 is meant to imply the effect of the mask on the cancellation signal is accounted for by modulator 90. If the signal processor needs to effectuate a cancellation signal of amplitude 10 at the cancellation point on the exterior surface and we know the mask introduces a simple amplitude reduction of 20% in this example then modulator 90 removes this reduction by dividing the input signal, 71, by 0.8. In other words if the signal processor sends out a signal of amplitude 10 via line, 71, then modulator 90 would represent a divide by 0.8 or equivalently a multiply by 1.25, resulting in signal, 10, equaling 12.5. The cancellation speakers would emit a signal of amplitude 12.5 which when observed at the point of cancellation would be of amplitude 10. Therefore modulator 90 effectively equals (1/PlantB). In FIGS. 20, 21 and 22 the designation “PlantA” is meant to imply that modulator 91 accounts for PlantA. In summary modulator 91 (PlantA) compensates for differences between where the voice is measured and where it effectively is to be cancelled. Modulator 90 adjusts the input cancellation signal to compensate for the effect of the mask on the cancellation signal. Modulator 90 effectively removes the effect of the mask on the cancellation signal such that the desired cancellation signal at the point of cancellation can be achieved. As stated earlier both PlantA and PlantB are dependent upon where the point of cancellation is relative to the measured voice and input cancellation signal respectively. Both modulator 90 and 91 can be incorporated into signal processor, 3.

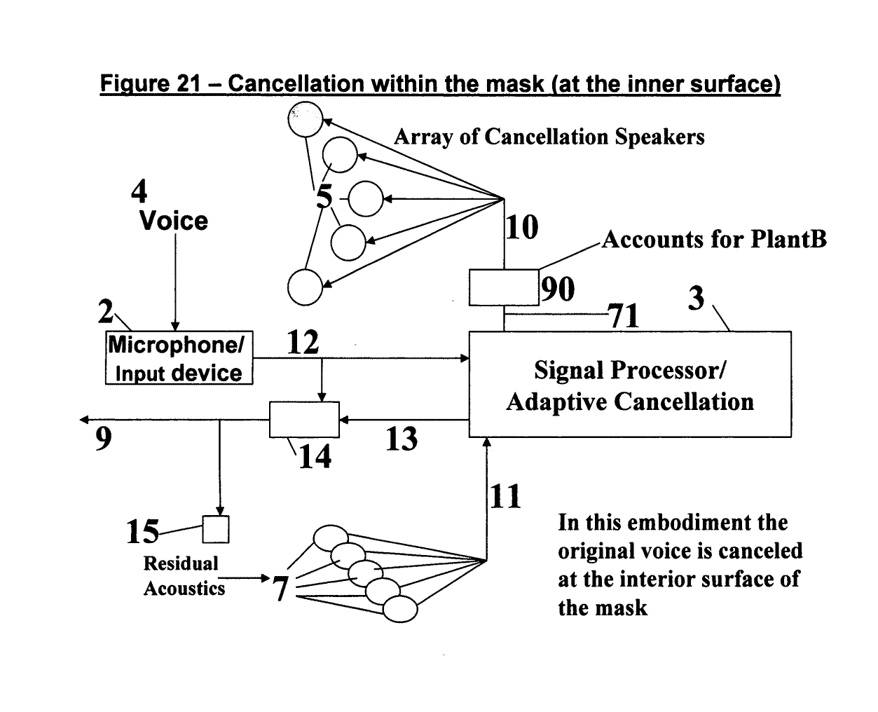

FIG. 21 diagrammatically depicts the case in which the cancellation point is the interior surface of the mask. Here the Voice signal 12 to be cancelled is that measured within the mask and no mask affects need to be taken into account—which is equivalent to saying modulator 91 in FIG. 20 is unity. In this case the cancellation signal is applied within the interior of the mask. Modulator 91 is not shown since it is effectively a multiply by one. Modulator 90 in this case represents the effect of the mask on the cancellation signal as observed at the interior surface of the mask. Modulator 90 multiplies the input cancellation signal 71 by a mathematical representation of the effect of the mask on the cancellation signal to output cancellation signal 10 applied to speakers 5. Modulator 90 compensates for the effect of the mask on the cancellation signal.

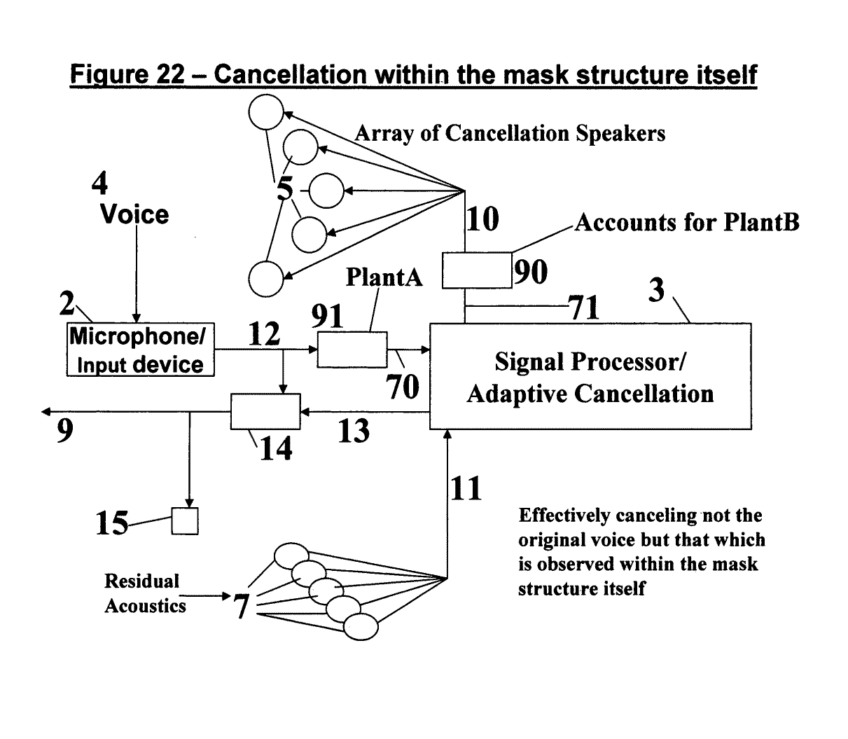

FIG. 22 diagrammatically depicts how the voice input signal 12, which is “corrupted” output from the input sensor(s) 2, is used to generate the transmitted “clean” voice signal 9. As previously stated, from the signal 12 is subtracted some form of the cancellation signal 13 derived from the signal processing algorithm wherein the resulting output signal 9 is then transmitted out to the recipient person or other party. Voice signal 12 input to modulator 91 which modifies the signal to account for the affect of the mask and inputs the resultant signal 70 into signal processor 3. This figure describes the situation where the voice is measured within the mask (in between the person's face and the interior surface of the mask), the point of cancellation is within the mask structure itself and the cancellation speakers are within the mask itself as well. The cancellation signal 71 output from the signal processor 3 is input to the modulator 90 which multiplies the signal by the mathematical representation of the affect of the mask on the cancellation signal to produce cancellation signal 10. Even though the point of cancellation is within the mask structure as are the cancellation speakers the mask structure still might effect the input cancellation signal such that the cancellation signal observed at the point of cancellation is different from the original cancellation signal.

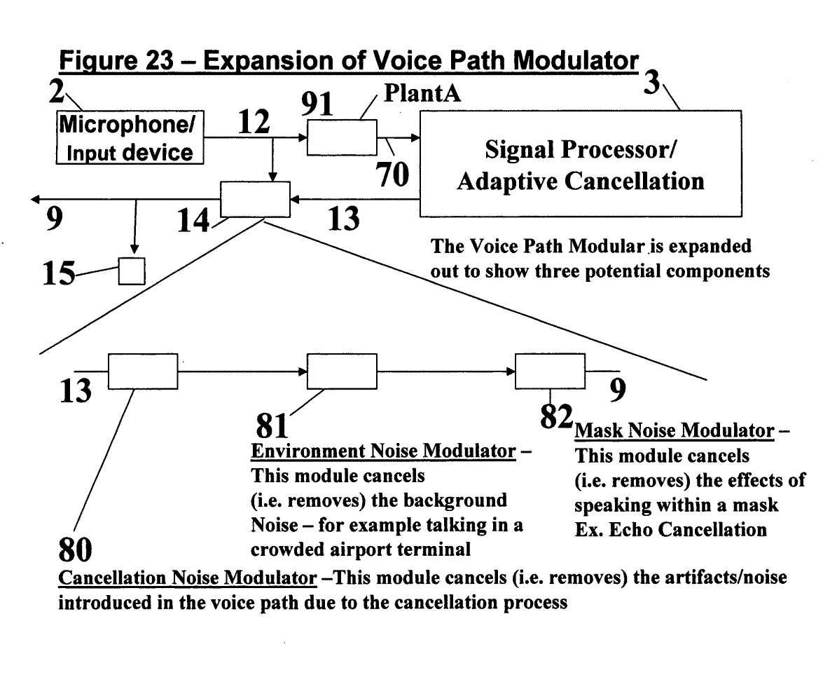

FIG. 23 shows three potential sub-module components of the voice path modulator, 14; an expansion of modulator 14. The first modulator, the Cancellation Noise Modulator, 80, removes any noise or artifacts due to the cancellation process. Given that no process is perfect there will be noise introduced into the transmission voice path due to the process of canceling the person's voice. The second modulator, the Environment Noise Modulator, 81, cancels background noise which is picked up by the system due to using said invention within a noisy environment like a crowded airport terminal, or within a noisy airplane cabin. Background noise cancellation is well documented and will not be expanded upon here. The third potential module, the Mask Noise Modulator, 82, removes the effects of speaking within a close chamber (i.e. a mask like structure). For example, this module would potentially perform echo cancellation.

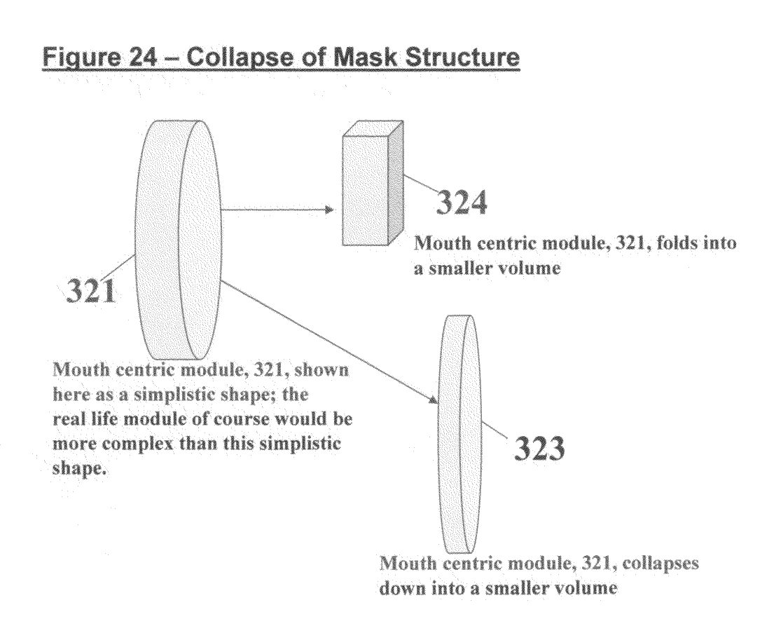

FIG. 24 shows how the mask like structure could be potentially reduced in volume for storage. The more rigid the mask like structure the more inconvenient it might be for user storage. The drawing simply presents two possible reductions in the mask like structure, 321, volume. Object 324 represents a folding or collapsing along one or more seems, or hinge like structures to achieve a folding on itself. Object 323 represents a scenario where it simply collapses down on itself. Of course there are many ways to potentially collapse the original shape. The point of the drawing is that users may wish to reduce the volume of the mask like structure 321 for storage.

While applicants have shown and described a preferred embodiment of the invention, it will be apparent to those skilled in the art that other and different applications may be made of the principles of the invention. It is desired therefore to be limited only by the scope or spirit of the appended claims.

What is claimed is:

1. (BASE SYSTEM—SINGLE SPEAKER, NO ERROR SENSORS, ALL MODULATORS) An electrical voice transmission system comprising:
an electrical transmission line;
a microphone for picking up the voice and delivering it to the transmission line;
a first modulator in said transmission line;
a speaker near the microphone for providing a voice cancellation sound;
a mask within which the speaker is mounted;
a second modulator in said transmission line before a signal processor which compensates for differences between where the voice is detected and where it is to be cancelled;
a third modulator in said cancellation line which compensates for differences between where the cancellation signal originates from and where the point of cancellation is;
a signal processor receiving input from the transmission line after the second modulator and providing output to the third modulator to generate a voice cancellation sound and to the first modulator to subtract from the transmission line downstream thereof the electrical voice cancellation sound and noise signals associated with speaking within a mask picked up before by the microphone.

2. (AN ARRAY OF SPEAKERS) A voice transmission system according to claim 1, wherein the speaker is one of a set of speakers near the microphone for providing voice cancellation sounds.

3. (SPHERICAL ARRAY OF SPEAKERS) A voice transmission system according to claim 2, wherein the set of speakers near the microphone for providing voice cancellation sound is arranged in a spherical pattern about the microphone.

4. (INCLUDE A SINGLE FAR FIELD SENSOR) A voice transmission system according to claim 1, and a far-field sensor more remote from the microphone than the speaker for generating error signals and sending them to the signal processor.

5. (ARRAY OF FAR FIELD SENSORS) A voice transmission system according to claim 4, wherein the far-field sensor is one of a set of far-field sensors more remote from the microphone than the speaker for generating error signals and sending them to the signal processor.

6. (DISTANCE BETWEEN FAR AND SPEAKERS) A voice transmission system according to claim 5, wherein the set of far-field sensors more remote from the microphone than the speaker for generating error signals and sending them to the signal processor is arranged in a spherical pattern about the microphone.

7. (ARRAY OF SPEAKERS & FAR) A voice transmission system according to claim 2, wherein the speaker is one of a set of speakers near the microphone for providing voice cancellation sounds, and a set of far-field sensors more remote from the microphone than the speakers for generating error signals and sending them to the signal processor.

8. (BOTH BUT NOW SPHERICAL) A voice transmission system according to claim 2, wherein the set of speakers near the microphone for providing a voice cancellation sound is arranged in a spherical pattern about the microphone, and a set of far-field sensors more remote from the microphone than the speakers for generating error signals and sending them to the signal processor is arranged in a spherical pattern about the microphone.

9. (ATTACHED TO TELEPHONE—SINGLE SENSOR) A device for attachment to a telephone handset having a microphone comprising:
a first modulator for insertion in a transmission line extending from said handset;
a speaker for mounting near the microphone for providing a voice cancellation sound,
a signal processor receiving input from the transmission line after a second modulator and providing output to a third modulator which provides output to the speaker to generate a voice cancellation sound and to the first modulator to subtract from the transmission line downstream thereof earlier electrical voice cancellation sound residual signals and noise signals associated with speaking within a mask picked up by the microphone.

10. (TELEPHONE PLUS ARRAY OF SPEAKERS) A device for attachment to a telephone handset having a microphone according to claim 9, wherein the speaker is one of a set of speakers mounted near the microphone for providing voice cancellation sounds.

11. (TELEPHONE & ARRAY PLUS SPHERICAL) A device for attachment to a telephone handset having a microphone according to claim 10, wherein the set of speakers mounted near the microphone for providing a voice cancellation sound is arranged in a spherical pattern about the microphone.

12. (TELEPHONE, SPEAKER, FAR) A device for attachment to a telephone handset having a microphone according to claim 9, and a far-field sensor for mounting more remote from the microphone than the speaker for generating error signals and sending them to the signal processor.

13. (TELEPHONE, SPEAKER, ARRAY OF FAR) A device for attachment to a telephone handset having a microphone according to claim 12, wherein the far-field sensor is one of a set of far-field sensors for mounting more remote from the microphone than the speaker for generating error signals and sending them to the signal processor

14. (TELEPHONE, SPEAKER, ARRAY OF FAR, SPHERICAL) A device for attachment to a telephone handset having a microphone according to claim 13, wherein the set of far-field sensors for mounting more remote from the microphone than the speaker for generating error signals and sending them to the signal processor are arranged in a spherical pattern about the microphone.

15. (SIDETONE & BASELINE) A voice transmission system according to claim 1, and another speaker near the microphone and connected to the signal processor for delivering voice as it was spoken into the microphone for hearing by the voice source.

16. (SPEAKER, FAR, SIDETONE) A voice transmission system according to claim 4, and another speaker near the microphone and connected to the signal processor for delivering voice as it was spoken into the microphone for hearing by the voice source.

17. (BOTH, SPHERICAL, SIDETONE) A voice transmission system according to claim 8, and another speaker near the microphone and connected to the signal processor for delivering voice as it was spoken into the microphone for hearing by the voice source.

18. (METHOD, SINGLE BOTH) In a method for transmitting voice over an electrical transmission line while canceling it spatially comprising:
picking up the voice via a microphone and delivering it to the transmission line;
operating a first modulator in said transmission line;
inputting from the transmission line before the first modulator into a second modulator and then input to a signal processor and providing outputs therefrom to a third modulator which then outputs to a speaker near the microphone to generate a voice cancellation sound and to the first modulator to subtract from the transmission line downstream from the first modulator electrical voice cancellation sound signal and noise signals associated with speaking within a mask picked up by the microphone.

19. (METHOD, SPHERE) In a method for transmitting voice over an electrical transmission line while canceling it spatially according to claim 18, and providing omnidirectional voice cancellation sound from a set of speakers of which said speaker is just one near the microphone and arranged in a spherical pattern about the microphone, and generating error signals and sending them to the signal processor from a set of far-field sensors more remote from the microphone than the speakers and arranged in a spherical pattern about the microphone.

20. (METHOD, SPHERE, SIDETONE) In a method for transmitting voice over an electrical transmission line while canceling it spatially according to claim 19, and delivering voice as it was spoken into the microphone for hearing by the voice source from another speaker near the microphone and that is connected to the signal processor.

21. (BACKGROUND NOISE CANCELLATION) A voice transmission system according to claim 1, wherein the signal processing algorithm includes cancellation of environmental background noise.

22. (BACKGROUND NOISE CANCELLATION) A voice transmission system according to claim 2, wherein the signal processing algorithm includes cancellation of environmental background noise.

23. (BACKGROUND NOISE CANCELLATION) A voice transmission system according to claim 4, wherein the signal processing algorithm includes cancellation of environmental background noise.

24. (PLANT TEMPERATURE DEPENDENCIES) A voice transmission system according to claim 2, wherein the second and third modulators are adjusted or adaptively altered depending upon temperature.

25. (VOICE LEAKAGE DETECTION & WARNING) A voice transmission system according to claim 2, wherein the signal processing algorithm includes a means to detect leakage of voice between the mask and the user's face as well as a means to compensate for said leakage and warn users of said condition.

26. (COLLAPSE OF MASK) A voice transmission system according to claim 2, wherein the mask structure incorporate means to collapse or reduce the volumetric dimensions of said mask.
